(19) United States
(12) Patent Application Publication
(10) Pub. No.: US 2011/0016932 A1
(43) Pub. Date: Jan. 27, 2011

(54) BURGARPROOF LOCK AND BURGARPROOF SYSTEM USING THE SAME

(75) Inventor: Chia-Fang Yu, Taipei County (TW)

Correspondence Address: COVENANT IP CONSULTING CO., P.O. BOX 34-306 TAIPEI CITY, TAIPEI, 10499, TW

(73) Assignee: SINOX CO., LTD, Taipei County (TW)

(21) Appl. No.: 12/370,616

(22) Filed: Feb. 13, 2009

(30) Foreign Application Priority Data
Feb. 15, 2008 (TW) 097105474

(51) Int. Cl. E05B 73/00; E05B 15/00; E05B 9/00; E05B 37/00

(52) U.S. Cl. 70/58; 70/431; 70/448

(57) ABSTRACT

The present invention provides a burglarproof lock using with a portable apparatus which has a slot. The burglarproof lock includes a lock apparatus and a protection portion. The lock apparatus has a housing, a first contact surface, and an engaging portion. The lock apparatus is disposed inside the housing. The first contact surface is formed on a side wall of the housing. The engaging portion connects with the lock apparatus and penetrates through the first contact surface. The protection portion has a second contact surface and a flange portion. The protection portion is disposed corresponding to the first contact surface, and an area projection of the flange portion is protruding from the first contact surface, wherein the engaging portion further penetrates through the second contact surface.

This application claims priority based on a Taiwanese patent application No. 097105474 filed on Feb. 15, 2008.

### BACKGROUND OF THE INVENTION

1. Field of the Invention

The present invention relates generally to a computer burglarproof lock; more particularly, the present invention relates to a burglarproof lock for using on a portable device having a slot.

2. Description of the Prior Art

As the development trend of technology, the design of communication and customer electronics products are toward lightweight, thinness, and compactness.

More and more portable products with the microscale concept are launched into the market. Portable products include, for example, a notebook, a mobile communication device, a digital voice/recorder, a music player, a portable video game player, and a digital camera. These products are usually valuable. In order to protect these products from being stolen, some burglarproof products are already in the market, such as Taiwan patent publication no. M255,888 (adjustable cable lock), Taiwan patent publication no. 582,423 (burglarproof lock device), and Taiwan patent publication no. 582,422 (slot lock device.)

Taiwan patent publication no. 582,423 discloses a burglarproof locked device including a lock body 22, a housing 24, and a hook 26, as shown in FIG. 1. When the lock body 22 moves toward the housing 24, the hook 26 is engaged within the slot 14 of the side casing 12 of the computer 10, i.e., the burglarproof lock 20 is locked. On the contrary, when the lock body 22 moves away from the housing 24 backwardly, the hook 26 will gather together, i.e., the burglarproof lock 20 is unlocked to separate from the computer 10. Because the burglarproof lock 20 provides with an extra lock 50 and a cable 52, when the burglarproof lock 20 engages with the slot 14 of the computer 10, the burglarproof lock 20 may be tilted due to the weight of itself, the cable 52 and the lock 50. The burglarproof lock 20 and the side casing 12 are not in close contacting and a gap exists between the burglarproof lock 20 and the side casing 12. Although the prior art unitizes a soft material, e.g. sponge 30, to fill in the gap; however, it is obviously that the result is unsatisfied.

Furthermore, since different produces have different designs and sizes, the thickness of the side casing 12 may various. Thus, when the burglarproof lock 20 engages with the computer 10, the hook portion 26 and the slot 14 are subject to the movements with respect to each other because the gap between the hook portion 26 and the slot 14 is not close enough. In addition, the surface of the housing 24 forms a smaller arm than the surface of the side casing 12; the force generally formed on the surface of the housing 24 is equal to or greater than the force formed on the side casing 12 while an external force generates a consistent moment (Moment=Force*Arm.) In other words, the side casing 12 may be broken/damaged easily due to the force generates by operating the burglarproof lock 20.

In summary, the side casing 14 of the computer 10 not only can be easily damaged, but also has poor burglarproof effects.

### SUMMARY OF THE INVENTION

It is an objective of the present invention to provide a burglarproof lock and a burglarproof system for preferable burglarproof effects.

It is another objective of the present invention to provide a burglarproof lock and a burglarproof system to effectively protect a casing wall of a portable device from being damaged.

It is another objective of the present invention to provide a burglarproof lock and a burglarproof system for the burglarproof lock connecting to the portable device closely.

It is another objective of the present invention to provide a burglarproof lock and a burglarproof system for use with various specifications of the portable device.

The present invent provides a burglarproof lock using with a portable device which has a slot. The burglarproof lock includes a lock apparatus, and a protecting portion. The lock apparatus has a housing, a first contact surface, and a engaging portion. The lock apparatus is disposed inside the housing. The first contact surface is formed on one side wall of the housing. The engaging portion is connecting with the lock apparatus, and protrudes from the first contact surface. The protecting portion has a second contact surface, and a flange portion. The flange portion is disposed corresponding to the first contact surface, and a projection area of the flange portion protrudes from the first contact surface. The engaging portion further protrudes from the second contact surface.

In a preferable embodiment, the protecting portion may integrally mold with the housing. The shape of the flange portion is selected from the group consisting of a rectangular shape, a round shape, an oval-shape, an abnormal shape, and the combinations thereof. When the flange portion contacts with the side wall of the housing, a basal area of the flange portion is greater than the basal area of the first/second contact surfaces. In other words, the basal area of the flange portion forms a greater arm than the basal area of the first/second contact surfaces. Therefore, the force formed on the flange portion per unit area is smaller than the force formed on the first/second contact surfaces while the external force generates a consistent moment (Moment=Force*Arm.) Accordingly, the engaging portion engaging with the slot may increase its stability and security. Furthermore, the engaging portion includes a movable stick and a fixed stick, and the movable stick is movably disposed on one side of the fixed stick. In other embodiments, however, the engaging portion may only be a movable stick, or formed a T-shaped stick, or a plug having at least one hook, or a screw. The above mentioned plug includes USB, IEEE1394, or other similar plugs.

The lock apparatus includes a key lock, a combination lock, a joined lock, or a mix of the key and combination lock. The side wall of the housing further has a push-button and a cable while the lock apparatus is the combination lock. The push-button may control the engaging portion to lock or unlock. The elastic and/or adjustable cable may be attached on the housing or other proper locations. The present invention further provides a spacer disposed between the flange portion and the casing wall. The spacer has at least one protrusion corresponding to a hollow formed on the first contact surface or the flange portion to offset the gap. The above mentioned spacer can be metal or alloys. In other embodiments, however, the spacer may include plastic, rubber, resin, fabric, sponge, or the combinations thereof.

The present invention further provides a burglarproof system including a portable device and a burglarproof lock. A slot is further formed on a casing wall of the portable device for engaging with an engaging portion of the burglarproof lock. The structure of the burglarproof lock is interpreted as foregoing embodiments, and would not illustrate hereunder.

### BRIEF DESCRIPTION OF THE DRAWINGS

FIG. 1 illustrates a conventional burglarproof lock;

FIG. 2a illustrates an exemplary perspective view of a lock apparatus combining with a protecting portion of the present invention;

FIG. 2b illustrates an exemplary perspective view of the lock apparatus been integratedly molded with the protecting portion of the present invention;

FIG. 3a illustrates a first embodiment of a flange portion of the present invention;

FIG. 3b illustrates a second embodiment of the flange portion of the present invention;

FIG. 3c illustrates a third embodiment of the flange portion of the present invention;

FIG. 5a illustrates an embodiment of engaging at least one spacer of the present invention;

FIG. 5b illustrates an exemplary connection of the burglarproof lock and a portable device;

FIG. 6 illustrates another preferred embodiment of the burglarproof lock according to the present invention; and

FIG. 7 illustrates an operation status of the present invention.

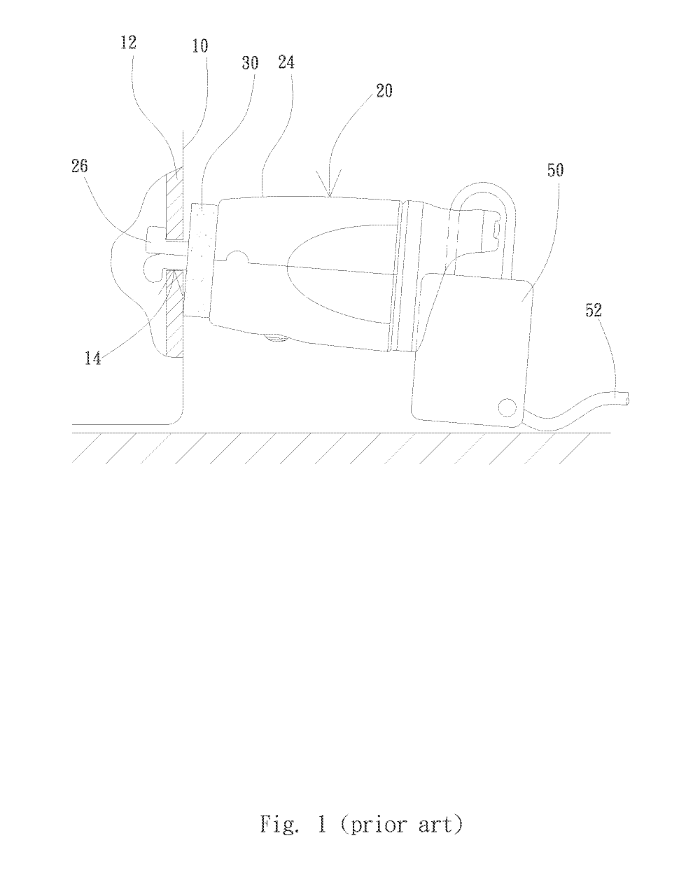

### DETAILED DESCRIPTION OF THE PREFERRED EMBODIMENT

The present invention provides a burglarproof lock and a burglarproof system with high stability and convenient engagement. The burglarproof lock is suitable for using with portable devices, such as portable computer, which preferably have a 3 mm×7 mm slot. In other embodiments, however, the slot may also include USB socket, IEEE1394 socket, RJ 45/RJ 47 socket, screw hole, or other proper sockets. The portable device may include LCD panel, portable communication device, digital video record (DVR), digital music player, electronic reader, video game player, portable media player, etc. In order to illustrate the present invention, various embodiments and structures are described below, and are accompanied with drawings.

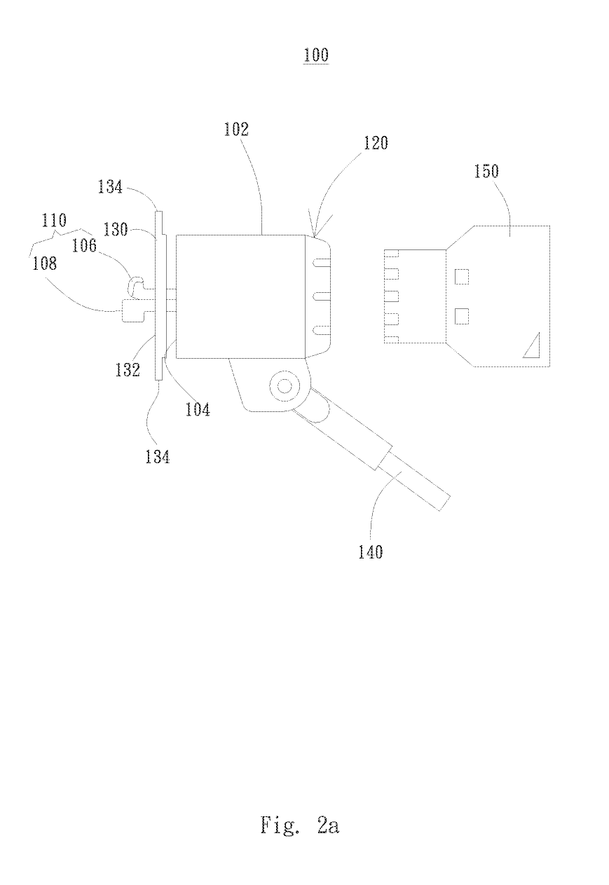

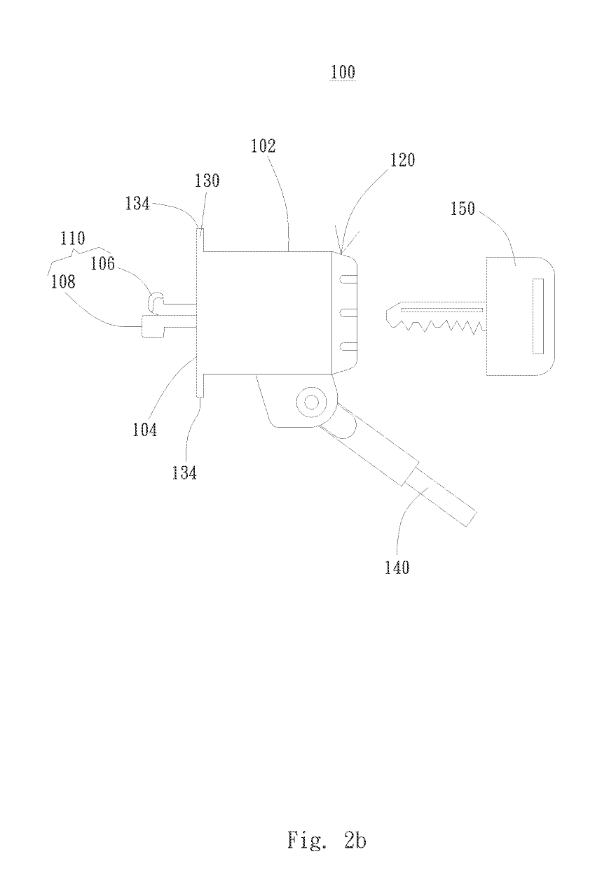

As FIG. 2a shows, the present invention of the burglarproof lock 100 includes a lock apparatus 120 and a protecting portion 130. The lock apparatus 120 has a housing 102, a first contact surface 104, and an engaging portion 110. The lock apparatus 120 is disposed inside the housing 102. The first contact surface 104 is formed on one side wall of the housing 102. The engaging portion 110 connects with the lock apparatus 120 and protrudes out of the first contact surface 104. In the embodiment shown in FIG. 2a, the lock apparatus 120 may include a key lock. The engaging portion 110 preferably includes a movable stick 106 and a fixed stick 108, and the movable stick 106 is movably disposed on one side of the fixed stick 108. In this embodiment, the key lock 120 controls the engaging portion 110 to move by turning a round key 150 (i.e. controls the movement of the movable stick 106 corresponding to the fixed stick 108.) In other words, the movable stick 106 is split from the fixed stick 108 when the key lock 120 is locked. On the contrary, the movable stick 106 and the fixed stick 108 are gathered together when the key lock 120 is unlocked. Please note that, in this embodiment, the motion of the burglarproof lock 100 is preferably a rotation motion.

The protecting portion 130 has a second contact surface 132 and a flange portion 134. The flange portion 134 is disposed corresponding to the first contact surface 104, and a projection area of the flange portion 134 protrudes out of the first contact surface 104. In the present embodiment, the first contact surface 104 is connected to the protecting portion 130, and the first contact surface 104 and the second contact surface 132 are respectively disposed toward the engaging portion 110. In addition, in the embodiment shown in FIG. 2a, the area formed between the center of the housing 102 to the edge of the flange portion 134 is greater than the area formed between the center of the housing 102 to the rim of the first contact surface 104. In other words, the basal area of the flange portion 134 is greater than the basal area of the first contact surface 104.

Moreover, the engaging portion 110 preferably protrudes out from the first contact surface 104 to the second contact surface 132. The movable and/or retractable cable 140 preferably attaches to the housing 102. In other embodiments, however, the cable 140 may also attach to the casing of the protecting portion 130.

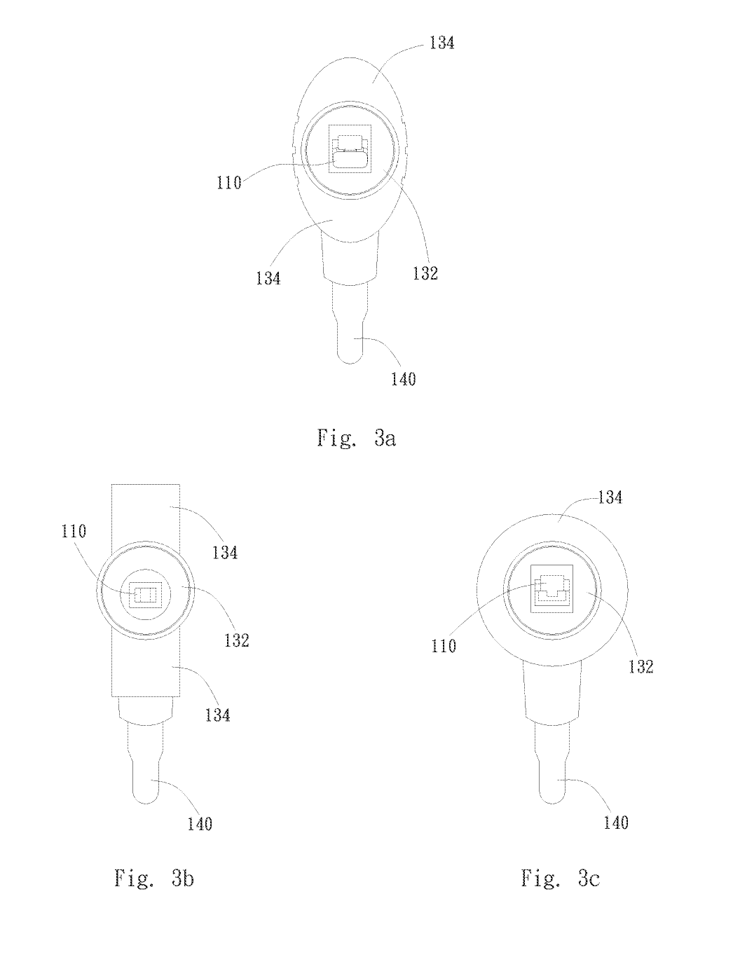

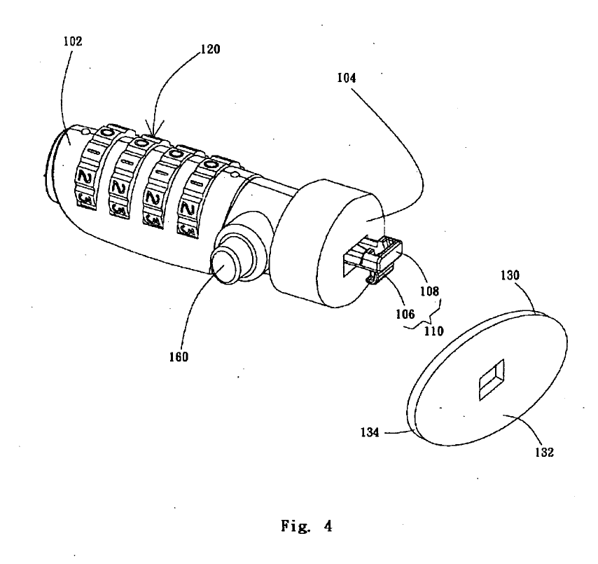

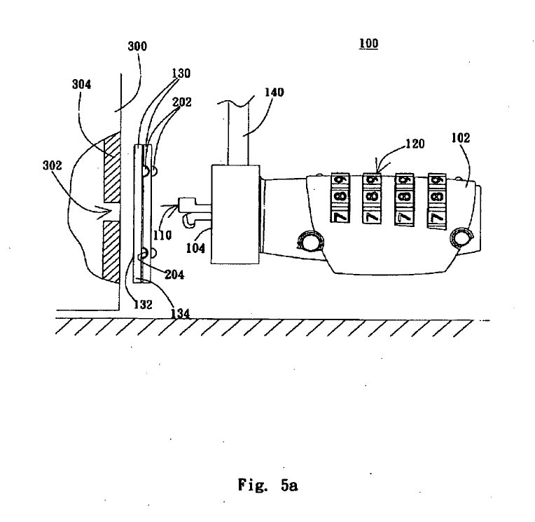

In the embodiment shown in FIG. 2b, the protecting portion 130 may also be integratedly molded with the housing 102 of the lock apparatus 120. In other words, one side surface of the housing 102 forms the first contact surface 104, and the second contact surface is preferably replaced the first contact surface 104. The flange portion 134 further is disposed extended along the rim of the housing 102. In this embodiment, the lock apparatus 120 may be opened by a regular key 150, therefore, the lock apparatus 120 may be various and operated by different keys. Furthermore, in the embodiment shown in FIG. 3a, the shape of the flange portion 134 is preferably shaped in an ellipse. In other embodiment shown in FIG. 3b, 3c, or other embodiments, however, the flange portion 134 may also shaped in rectangle, circular, irregular form, or the combinations thereof.

In the embodiment shown in FIG. 3b, the engaging portion 110 may include a T-shaped stick, and the locked or unlocked status can be achieved by operating the T-shaped stick. In other words, the partial T-shaped stick extends into the slot and then rotates/drives the T-shaped stick, so that the T-shaped stick can engage with the slot of the casing wall. In the embodiment shown in FIG. 3c, however, the engaging portion 110 may only disposed a movable stick, the locked or unlocked status can be achieved by controlling the rise, or droop of the movable stick. In other words, the movable stick may also extend into the slot and then splits/gathers/drives the movable stick, so that the movable stick can engage with the slot of the casing wall.

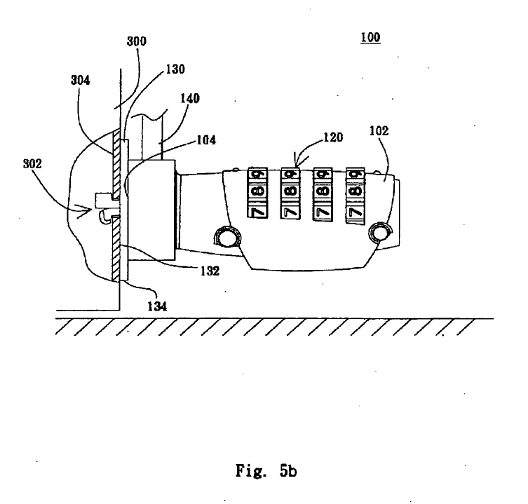

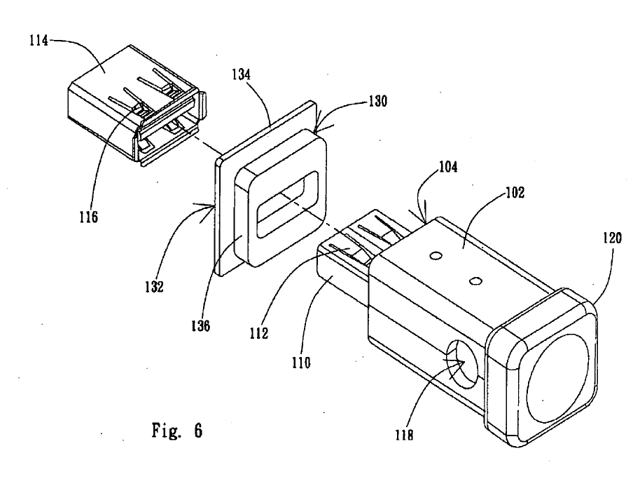

As FIG. 4 shows, the lock apparatus 120 may also include a combination lock. The side wall of the housing 102 further has a push-bottom 160 for controlling the engaging portion 110. The push-bottom 160 cannot drive the engaging portion 110 and the shaft (not illustrated) of the combination lock 120 when the combination lock 120 is locked. In other words, the movable stick 106 is keeping split from the fixed stick 108. On the contrary, when the combination lock 120 is unlocked, the push-bottom 160 can be pushed to drive the shaft and the engaging portion 110 simultaneously, such that the movable stick 106 and the fixed stick 108 combine together (not illustrated). In this embodiment, the second contact surface 132 is preferably connecting with the basal area of the flange portion 134, i.e., the second contact surface 132 and the basal area of the flange portion 134 form together in a plane, such that the burglarproof lock 120 can provide a greater basal area of the second contact surface 132 to contact with the portable device (refer to FIG. 5a.)

The present invention further provides a burglarproof system including a portable device 300 and a burglarproof lock 100, as shown in FIG. 5a, and FIG. 5b. The above mentioned portable device 300 further may have a slot 302 formed on the casing wall 304. The portable device 300 may include portable computer, LCD panel, portable communication device, digital video recorder (DVR), digital music player, electronic reader, video game player, portable media player, or other proper electrical devices. The lock apparatus 120 of the burglarproof lock 100 may include a key lock, combination lock, joined lock, a mix of the key and combination lock, or other locks.

Since a gap normally exists between the second contact surface 134 and the casing wall 304 due to several reasons, thus, in the embodiment shown in FIG. 5a, further provides at least one protecting portion 130 disposed between the second contact surface 134 and the casing wall 304. According to the dimensions of the gap, in this embodiment, there can be disposed two protecting portion 130 to fill up the gap. In the embodiment shown in FIG. 5b, however, there can be disposed on only one protecting portion 130. The protecting portion 130 is preferable having a spacer function and has at least one protrusion 202 corresponding to a hollow 204 of another protecting portion 130. In order words, the protrusion 202 is disposed on one side surface of the protecting portion 130, and the hollow 204 may form on the other side surface of another protecting portion 130, or the first contact surface 104. In addition, the material of the protecting portion 130 includes metal, plastic, rubber, resin, fabric, sponge, or the combinations thereof.

FIG. 5b provides, a perspective view of the burglarproof system engages with the portable device according to the present invention. The basal area of the flange portion 134 is preferably completely contacted with the casing wall 304 of the portable device 300 when the burglarproof lock 100 engages with the slot 302 of the portable device 300. Moreover, the basal area of the flange portion 134 is greater than the basal area of the first contact surfaces 104. In other words, the basal area of the flange portion 134 forms a greater arm than the basal area of the first contact surfaces 104. Therefore, the force formed on the flange portion 134 per unit area is smaller than the force formed on the first contact surfaces 104 per unit area when the external force generates a consistent moment (Moment=Force*Arm.) Accordingly, the casing wall 304 of the portable device 300 would not be damaged during the operation, and the engagement between the engaging portion 110 and the slot 302 may also become more stable.

As FIG. 6 shown, a perspective view of the burglarproof system engages with the portable device according to the present invention. The lock apparatus 120 may be a joined lock which combines with the protecting portion 130. The joined lock can be locked or unlocked by moving the lock apparatus 120 toward or away from the housing 102. The protecting portion 130 is preferably having a rectangular flange portion 134 and a protrusion portion 136 which is disposed corresponding to the first contact surface 104. In other embodiments, however, the protecting portion 130 may be integratedly molded with the housing 102. The engaging portion 110 of the burglarproof lock 100 may also include a plug, and the side wall of the plug has at least one hook 112 for engaging with a shell fragment 116 of the slot 114. The above mentioned plug is preferably a USB plug. The slot 114 may be a socket corresponding to the plug and mounted within the portable device (not shown in this Figure.) In other embodiments, however, the plug may include a wire plug, network plug, or other plugs.

When the lock apparatus 120 moves toward the housing 102, the hook 112 of the lock apparatus 120 engages with the shell fragment 116 of the socket 114 to achieve the locked status. On the contrary, when the lock apparatus 120 moves away from the housing 102, the hook 112 releases the shell fragment 116 to lock the system. In this embodiment, the motion of the burglarproof lock is preferably a straight-line motion. Please note that the lock apparatus 120 needs to have an extra cable or lock (such as the key lock, the combination lock, or other proper locks, not illustrated) to penetrate a lock hole 118 of the housing 102 to provide the burglarized function. When the lock apparatus 120 moves away from the housing 102, the lock hole 118 and a cavity (not illustrated) formed inside the lock apparatus 120 is unconnected, so that the lock or the cable cannot penetrate the lock hole 118 and the cavity. When the lock apparatus 120 moves toward the housing 102, the lock hole 118 and the cavity are connected, so that the lock or the cable can be penetrated into the lock hole 118 and the cavity.

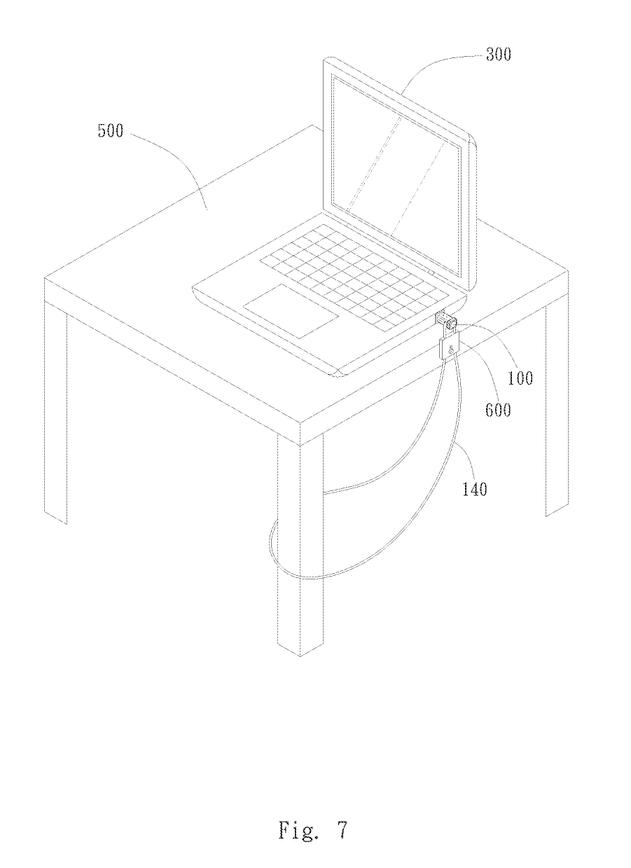

FIG. 7 shows another embodiment of the present invention. The burglarproof lock 100 is preferably a joined lock having a lock hole. When the burglarproof lock 100 engages with the portable device 300, the burglarproof system still needs a lock 600 having an extra cable 140. The cable 140 which controls by the lock 600 is preferably tied on a fixture 500, in order to prevent the portable device 300 from lost or stolen. In the embodiment shown in FIG. 7, the fixture 500 is a leg of the desk. In other embodiments, however, the fixture 500 may be a handling or other proper objects in the nature environment.

From the foregoing, it shall be appreciated that specific embodiments of the invention have been described herein for purposes of illustration, but that various modifications and alterations may be made by those skilled in the art without deviating from the spirit and scope of the invention. For example, it shall be understood that there is no intention to limit the invention to the specific forms disclosed, but on the contrary, the invention is to cover all modifications, alternate constructions and equivalents falling within the spirit and scope of the invention. Accordingly, the invention is not limited except as by the appended claims.

What is claimed is:

1. A burglarproof lock, comprising:
a lock apparatus having a housing, a first contact surface, and a engaging portion, the lock apparatus disposed inside the housing, the first contact surface being formed on a side wall of the housing, the engaging portion connecting with the lock apparatus, and protruding from the first contact surface; and
a protecting portion having a second contact surface, and a flange portion, the flange portion disposed corresponding to the first contact surface, a projection area of the flange portion protruding from the first contact surface, wherein the engaging portion further protrudes from the second contact surface.

2. The burglarproof lock of claim 1, wherein the protecting portion is integratedly molded with the housing.

3. The burglarproof lock of claim 1, wherein the shape of the flange portion is selected from the group consisting of a rectangular shape, a round shape, an oval-shape, an abnormal shape, or the combinations thereof.

4. The burglarproof look of claim 1, wherein the engaging portion includes a movable stick and a fixed stick, and the movable stick is movably disposed on one side of the fixed stick.

5. The burglarproof lock of claim 1, wherein the engaging portion includes a T-shaped stick.

6. The burglarproof lock of claim 1, wherein the engaging portion includes a plug having at least one hook.

7. The burglarproof lock of claim 1 further includes a cable which is movably attached on the housing.

8. The burglarproof lock of claim 1 further includes a cable which is movably disposed on the protecting portion.

9. The burglarproof lock of claim 1, wherein the lock apparatus includes a key lock.

10. A burglarproof system, comprising:
a portable device having a slot formed on a casing wall thereof;
a burglarproof lock, including:
a lock apparatus having a housing, a first contact surface, and an engaging portion, the lock apparatus disposed inside the housing, the first contact surface being formed on a side wall of the housing, the engaging portion connecting with the lock apparatus, and protruding from the first contact surface; and
a protecting portion having a second contact surface, and a flange portion, the flange portion disposed corresponding to the first contact surface, a projection area of the flange portion protruding from the first contact surface, wherein the engaging portion further protrudes from the second contact surface, and engages with the slot.

11. The burglarproof system of claim 10, wherein the protecting portion is integratedly molded with the housing.

12. The burglarproof system of claim 10, wherein the shape of the flange portion is selected from the group consisting of a rectangular shape, a round shape, an oval-shape, an abnormal shape, or the combinations thereof.

13. The burglarproof system of claim 10, wherein the engaging portion includes a movable stick and a fixed stick, and the movable stick is actively disposed on one side of the fixed stick.

14. The burglarproof system of claim 10, wherein the engaging portion includes a T-shaped stick.

15. The burglarproof system of claim 10, wherein the engaging portion includes a plug having at least one hook.

16. The burglarproof system of claim 10, wherein the motion of the engaging portion includes a straight-line motion corresponding to the housing.

17. The burglarproof system of claim 10, wherein the motion of the engaging portion includes a rotational motion corresponding to the housing.

18. The burglarproof system of claim 10 further includes a cable which is movably attached on the housing.

19. The burglarproof system of claim 10 further includes a cable which is movably attached on the protecting portion.

20. The burglarproof system of claim 10, wherein the lock apparatus includes a combination lock.
